(19) United States
(12) Patent Application Publication
(10) Pub. No.: US 2011/0239580 A1
(43) Pub. Date: Oct. 6, 2011

(54) PARAPET ANCHOR

(75) Inventors: Joshua A. Rodewald, Lake City, MN (US); Andrew Babiak, Winnipeg (CA); Andrew C. Strauss, Goodhue, MN (US); Nathan C. Meyer, Kellogg, MN (US); Matthew D. Hanson, Red Wing, MN (US); Lonnie P. Thompson, Welch, MN (US); Brian J. Schafer, Red Wing, MN (US)

(73) Assignee: D B Industries, Inc.

(21) Appl. No.: 12/751,619

(22) Filed: Mar. 31, 2010

(51) Int. Cl. E04B 1/38; A62B 35/00

(52) U.S. Cl. 52/699; 248/237

(57) ABSTRACT

A parapet anchor is provided. The parapet anchor includes a frame, at least one adjustment member and a davit mount. The frame is configured and arranged to fit around a portion of a parapet. The at least one adjustment member is movably coupled to the frame to selectively engage the parapet to secure the frame to the parapet. Moreover, the davit mount is coupled to the frame and is configured and arranged to support a davit. The davit in turn can be used as a support structure upon which a lifeline can be coupled.

### BACKGROUND

Fall arrest systems that protect workers in the event of a fall are used in work locations where a fall could cause injury or death. A typical fall arrest system includes a safety harness that is donned by the worker, a lifeline that is attached to the harness, and a support structure in which the lifeline is connected. In some situations, such as in the construction of a new building, a suitable support structure to connect the lifeline to can be a challenge to find.

For the reasons stated above and for other reasons stated below which will become apparent to those skilled in the art upon reading and understanding the present specification, there is a need in the art for an efficient and effective means to provide a support structure for a lifeline in a risk area that is void of adequate support structures.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a parapet anchor is provided. The parapet anchor includes a frame, at least one adjustment member and a davit mount. The frame is configured and arranged to fit around a portion of a parapet. The at least one adjustment member is movably coupled to the frame to selectively engage the parapet to secure the frame to the parapet. Moreover, the davit mount is coupled to the frame and is configured arraigned to support a davit. The davit in turn can be used as a support structure to which a lifeline can be coupled.

### BRIEF DESCRIPTION OF THE DRAWINGS

The present invention can be more easily understood and further advantages and uses thereof more readily apparent, when considered in view of the detailed description and the following figures in which:

FIG. 1 is a side perspective view of an assembled parapet anchor of one embodiment of the present invention;

FIG. 2 is a side exploded perspective view of the parapet anchor of FIG. 1;

FIGS. 3 and 4 are a side views of the parapet anchor of FIG. 1 being positioned to engage a parapet;

FIGS. 5A and 5B are side views of select portions of the parapet anchor of FIG. 1;

FIG. 6 is a side view of the parapet anchor of FIG. 1 attached to a parapet;

FIG. 7A is a side view of the parapet anchor of FIG. 1 with a davit arm attached;

FIG. 7B is a side perspective view of a davit mount of one embodiment of the present invention;

FIG. 8 is a side view of the parapet anchor of FIG. 1 being removed from a parapet; and

FIG. 9 is a back side perspective view of a portion of the parapet anchor of FIG. 1 being prepared for transport or storage.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

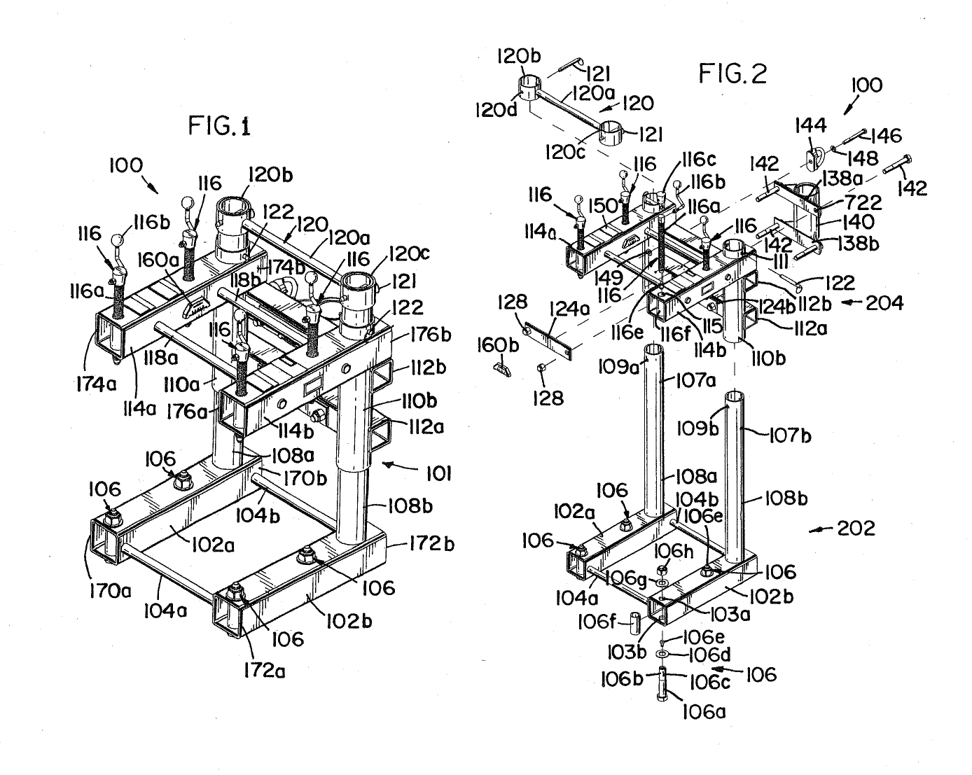

Embodiments of the present invention include parapet anchors that can be attached to a parapet. Embodiments of the parapet anchor can then be used as a stable support structure for the attachment of lifelines and the like. Hence, the parapet anchor can provide a stable support structure in a location where stable supports are typically not found such as, but not limited to, a construction location. A parapet anchor 100 of an embodiment is illustrated in FIGS. 1 and 2. The parapet anchor 100 includes a lower assembly 202 and an upper assembly 204 as illustrated in FIG. 2. When the lower assembly 202 is coupled to the upper assembly 204, a generally C-shaped frame 101 is formed as illustrated in FIG. 1. The frame 101 is coupled around a parapet as further described below.

The lower assembly 202 of the parapet anchor 100 includes a first lower member 102a and a second lower member 102b that are spaced apart by first and second lower frame spacers 104a and 104b. In particular, the first lower member 102a includes a first end 170a and a second end 170b. The second lower member 102b includes a first end 172a and second end 172b. The first lower frame spacer 104a is positioned between the first lower member 102a and the second lower member 102b proximate the first end 170a of the first lower member and proximate the first end 172a of the second lower member 102b. The second lower frame spacer 104b is positioned proximate the second end 170b of the first lower member 102a and proximate the second end 172b of the second lower member 102b such that the first lower member 102a is spaced in a parallel fashion from the second lower member 102b by the first and second frame spacers 104a and 104b. In the embodiment illustrated in FIGS. 1 and 2, the first lower member 102a and the second lower member 102b are respectively made from tubular members that are square in shape.

Each lower member 102a and 102b of the lower assembly 202 has a pair of lower engaging members 106 coupled thereto. Each engaging member 106 includes a bolt 106a having an external threaded portion 106c as illustrated in FIG. 2. Bolt 106a further includes an internal threaded bore 106b. A washer 106d is received around the bolt 106a to abut a head of bolt 106a. An engaging head 106e threadably engages an internal threaded bore 106b of the bolt 106a. Bolt 106a is then received through apertures in the respective lower members 102a and 102b such as aperture 103a and 103b illustrated in the second lower member 102b in FIG. 2. Spacers 106f are received in the respective first and second lower members 102a and 102b to provide a passage and support for respective bolts 106a of the engaging members 106. A second washer 106g is then received around the external threads 106c of the bolt 106a to abut a surface of the respective first or second lower members 102a and 102b. A nut 106h then engages the external threads 106c of the bolt 106a to secure the respective engaging member 106 to the respective first and second lower members 102a and 102b. As illustrated, the engaging head 106e extends above nut 106h of the fastener 106 on each engaging member 106. In one embodiment an engaging head 106e is an engaging screw. The engaging head 106e of each engaging member 106 can be replaced if they become worn.

The lower assembly 202 also includes a pair of lower support members 108a and 108b. In particular, the first lower support member 108a extends generally perpendicular from the first lower member 102a proximate the second end 170b of the first lower member 102a. The second lower support member 108b extends generally perpendicular from the second lower member 102b proximate the second end 172b of the second lower member 102b. In one embodiment the first and second lower support members 108a and 108b are tubular in shape. The first lower support member 108a includes a pair of spaced passages 109a and 107a that extend generally in a perpendicular fashion, with respect to each other, through the first lower support member 108a. Passages 109a and 107a are located proximate a terminal end of the first lower support member 108a. Similarly the second lower support member 108b includes a pair of perpendicular spaced passages 109b and 107b that are located proximate a terminal end of the second lower support member 108b.

The upper assembly 204 of the parapet anchor 100 includes a first upper support member 110a and a second support member 110b. In the embodiment illustrated in FIGS. 1 and 2, the first upper support member 110a and the second upper support member 110b are tubular in shape. Each of the first and second upper support members 110a and 110b have a diameter that is slightly larger than the diameter of the respective first and second lower support members 108a and 108b. The first lower support member 108a is selectively received in the first upper support member 110a and the second lower support member 108b is selectively received in the second upper support member 110b. Passages 111 in respective first and second upper support members 110a and 110b are aligned with respective passage 107a and the first lower support member 108a and passage 107b in the second lower support member 108b. Detent pins 122 are positioned in passages 111 in the first and second upper support members 110a and 110b and in passages 107a of the first lower support member 108a and the second passage 107b in the second lower support member 108b to selectively couple the upper assembly 204 to the lower assembly 202.

The upper assembly 204 further includes a pair of upper members 114a and 114b that extend from the first upper support member 110a and the second upper support member 110b respectively. In particular, the first upper member 114a extends generally perpendicular from the first upper support 110a and the second upper member 114b extends generally perpendicular to the second upper support member 110b such that the parapet anchor 100 has a frame 101 that is generally C-shaped. The first upper member 114a includes a first end 174a and a second end 174b. In one embodiment the first upper support 110a passes through an opening in the first upper member 114a proximate the second side 174b of the first upper member 114a. In this embodiment, a portion of the upper support member 110a that includes passage 111 extends above the first upper member 114a. The second upper member 114b includes a first end 176a and a second end 176b. The upper support member 110b in one embodiment passages through an opening in the second upper member 114b proximate the second end of the second upper member 114b. Likewise, a portion of the second upper support member 110b extends above the second upper member 114b such that passage 111 in the second upper support member 110b is above the second upper member 114b. In one embodiment, the first upper member 114a and the second upper member 115 have a square tubular shape as illustrated in FIGS. 1 and 2. When the upper assembly 204 is coupled to the lower assembly 202, the first upper member 114a runs parallel to and is aligned with the first lower member 102a and the second upper member 114b runs parallel to and is aligned with the second lower member 102b in an embodiment.

A pair of upper spacers 118a and 118b coupled between the first and second upper members 114a and 114b provide spacing and support for the first and second upper members 114a and 114b. Each of the first and second upper members 114a and 114b has a pair of passages 115. Adjusting member spacers 116f are received in the respective first and second upper members 114a and 114b to further define passages 115 through the respective first and second upper members 114a and 114b. Adjustment members 116 are received in the respective passages 115 in the first and second upper members 114a and 114b. In particular, each adjustment member 116 includes a threaded shaft 116a that is threadably engaged within a respective passage 115 through a respective first or second upper member 114a or 114b. Each adjustment member 116 further includes an adjustment handle 116b that is coupled to a first end of the threaded shaft 116a. A second end of the threaded shaft 116a has a threaded bore that is designed to receive an engaging head 116e. Engaging head 116e is a screw in one embodiment. Further in one embodiment than each adjustment member 116 includes a cap portion 116c that is coupled about the first end of the treaded shaft 116a in which the handle portion 116b is coupled.

The parapet anchor 100 further includes a handle 120. Handle 120 includes an elongated member 120a (grasping rod) that is coupled between a first tubular section 120b (first connection flange) and a second tubular section 120c (second connection flange). The first connection flange 120b and second connection flange 120c each have a diameter that is slightly larger than the diameter of the respective first lower support member 108a and the second lower support member 108b. Each of the first and second connection flange 120b and 120c having a passage 120d passing there though. The respective passages 120d through the first connection flange 120b aligns with passage 109a of the first lower support member 108a and passage 120d of the second connection flange 120c aligns with passage 109b of the second lower support member 108b when the handle 120 is connected to frame 101. In particular, a detent pin 121 is passed through passages 120 of the first connection flange 120b and passage 109a of the first lower support member 108a. Likewise another detent pin 121 is passed through passage 120d of the second connection flange 120c and the end passage 109b of the second lower support member 108b thereby coupling the handle to the frame 101 of the parapet anchor 100.

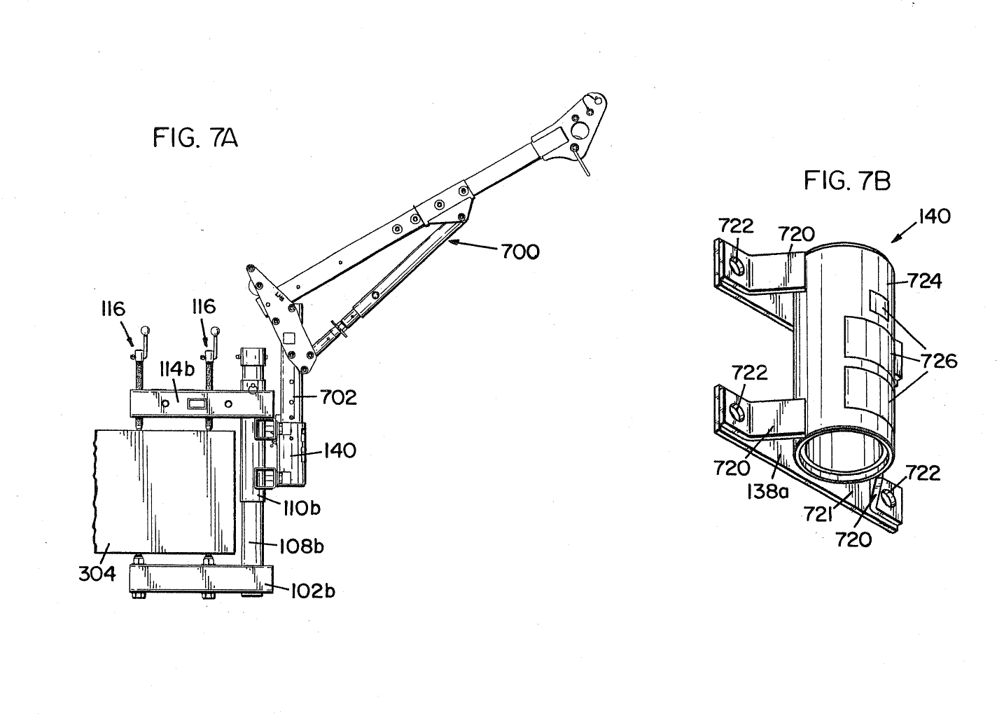

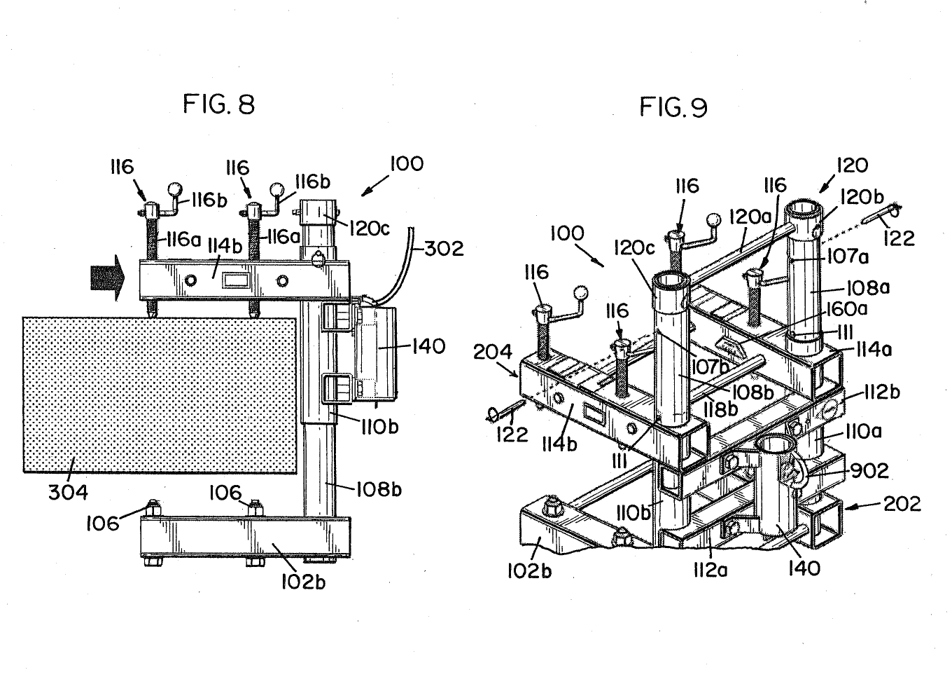

A davit mount 140 is coupled to the frame 101. An illustration of davit mount 140 is illustrated in FIG. 7B. Davit mount 140 includes a tubular member 724. Warning labels 726 regarding the use of the parapet anchor 100 can be placed on the tubular member 124. Coupled proximate opposite ends of the tubular member 724 are davit mounting plates 138a and 138b and respective davit braces 720. Apertures 720 pass though the respective davit mounting plates 138a and 138b and davit braces 720. Apertures 720 are used to mount the davit mount 140 to first and second mounting members 112a and 112b of frame 101 as illustrated in FIG. 2. The first and second mounting members 112a and 112b are mounted across surfaces of the first and second upper support members 110a and 110b. In particular, fasteners 142 (bolts in this embodiment) pass through apertures 720 in respective davit brackets 138a and 138b and through respective passages in the first mounting member 112a and the second mounting member 112b. The fasteners 142 further pass through support plate 124a and 124b that are positioned to abut the respective first mounting member 112a and the second mounting member 112b. Washer 148 and 149 are received on the respective fasteners 142, 146 and nuts 128 threadably engage the respective fasteners 142, 146 to couple the davit mount 142 to the frame 101 of the parapet anchor 100. In one embodiment, a connector 144 which includes a base and a looped portion is mounted to the second mounting member 112b via fastener 146. The connector 144 provides a first anchor point to the parapet anchor 100. A fastener 146 passes through a passage in the second mounting member 112b and is coupled with a second mounting member 112b by washers 148, 149 and a nut 128. In one embodiment the first upper member 114a and the second upper member 114b includes warning labels 150 on an outer surface. One embodiment further includes levels such as a first level 160a coupled to the first upper member 114a and a second level 160b coupled to an upper support member such as the second upper support member 112b. The levels 160a and 160b help insure the parapet anchor 100 is properly positioned when attached to a parapet.

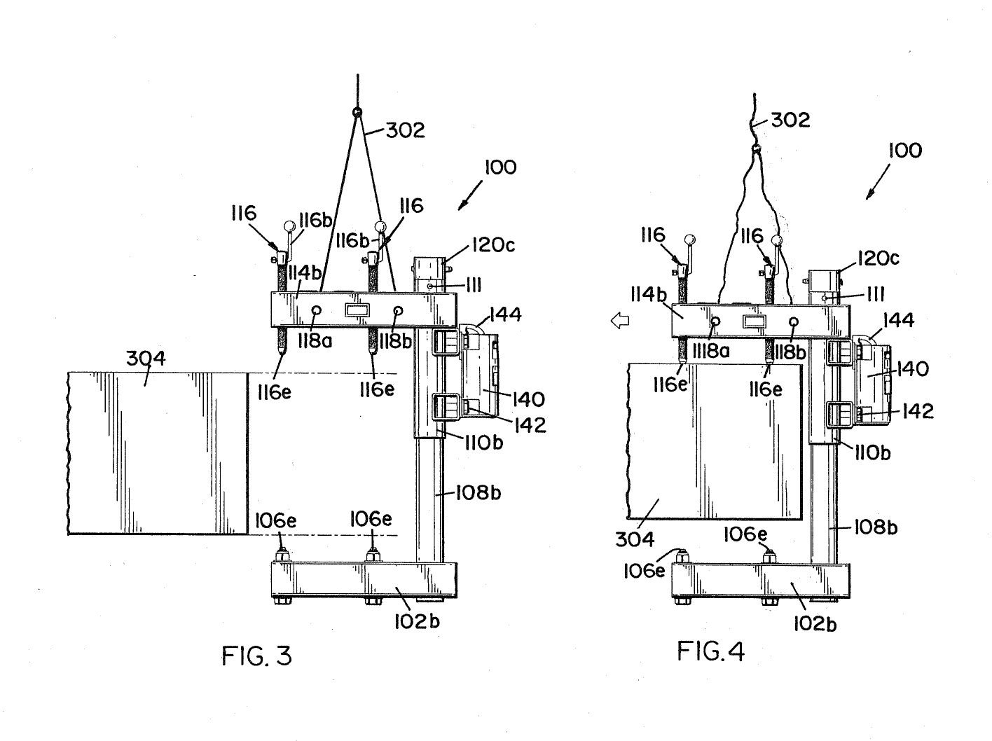

Referring to FIGS. 3 and 4, the positioning of the parapet anchor 100 on a structure 304 (a parapet) is illustrated. In one embodiment, a cable 302 (or strap) coupled to a hoist (not illustrated) is used to position the parapet anchor 100 into position relative to the parapet 304. In particular, the cable 302 in one embodiment is coupled across upper spacers 118a and 118b of the parapet anchor 100. The parapet anchor 100, in one embodiment has a center of gravity that allows the parapet anchor 100 to be properly orientated to be received around the parapet 100 when cable 302 is coupled to the upper spacers 118a and 118b. The parapet anchor 100 is hoisted to a position that is within easy reach of an installer. In particular, the parapet anchor 100 is positioned so that the parapet 304 fits between the upper engaging heads 116e of the adjustment members 116 and the lower engaging heads 106e of the lower engaging members 106 as illustrated in FIG. 3. As further illustrated in FIG. 3, detents pins 122 are removed from passages 111. This allows handle 120 to be lowered such that the respective first connection flange 120b and second connection flange 120c rests on respective ends of the first upper support member 110a and the second upper support member 110b. This provides extra space between the upper members 114a and 114b and the lower members 102a and 102b to ease in positioning of the parapet anchor 100 about the parapet 304. The installer grasps the upper spacer 118a to manipulate the parapet anchor 100 towards the installer to properly position the parapet 304 between C-shaped frame 101 of the parapet anchor 100 as illustrated in FIG. 4.

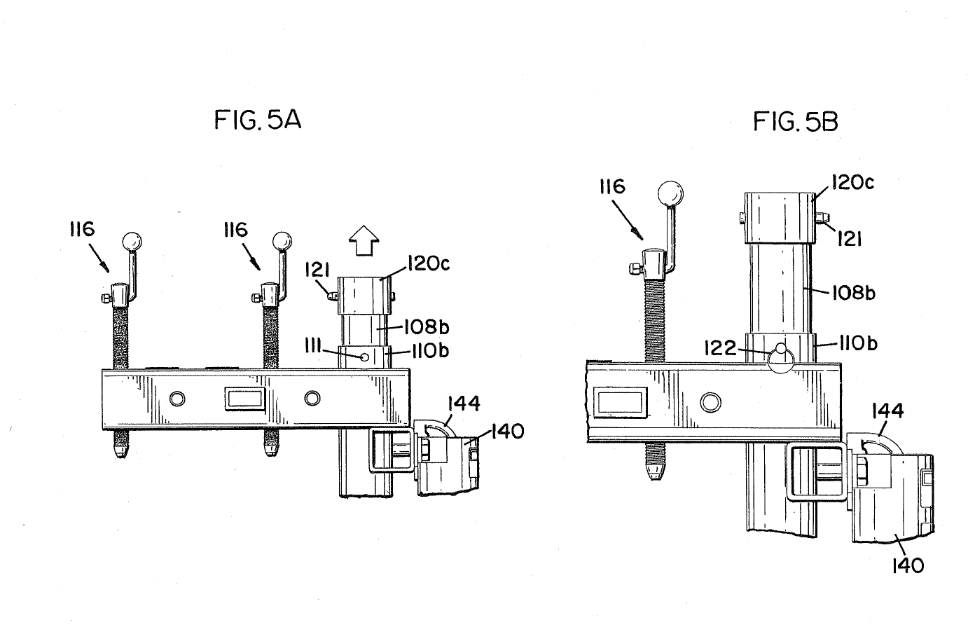

Once, the parapet anchor 100 is properly positioned about the parapet 304, handle 120 is grasped by the installer and pulled up as illustrated in the partial side-view of FIG. 5A. This action decreases the distance between the upper members 114a and 114b and the lower members 102a and 102b. Handle 120 is pulled up until passages 111 in the upper supper member 110a and 110b are aligned with passages 107a and 107b in the respective first and second lower support members 108a and 108b. Detent pins 122 are then passed through the aligned passages to couple the upper members 114a and 114b in a static position in relation to the lower members 102a and 102b. This is illustrated in the partial side view of FIG. 5B.

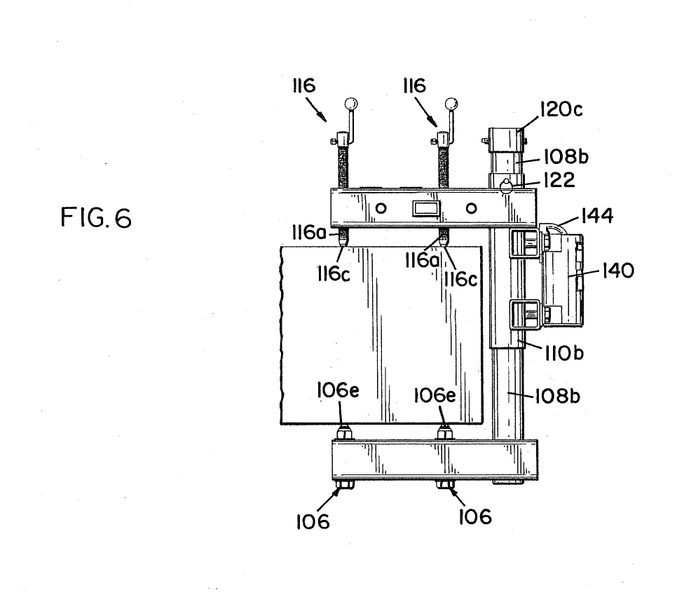

The parapet anchor 100 is then secured to the parapet 304, as illustrated in FIG. 6. In particular, adjustment handles 116b of the adjusting members 116 are rotated to cause the upper engaging heads 116e of the adjusting members 116 to engage a top surface of the parapet 304 and the lower engaging heads 106e of engaging members 106 to engage a bottom surface of the parapet 304. Hence, the parapet becomes sandwiched between the adjusting members 116 and the engaging members 106. Levels 160a and 160b can be read by the installer to adjust the adjustment members 116 so that the parapet anchor 100 is properly leveled on the parapet 304. Once the parapet anchor 100 is attached to the parapet 304, the hoisting cable 302 (if used) can be removed. Referring to FIG. 7A a davit arm 700 is then inserted into davit mount 140. The davit arm 700 can then be used as a stable support for life lines, and the like, attached to a safety harness of a user.

In removing the parapet anchor 100 from the parapet 304, the davit arm 700 is first removed from the davit mount 140. A hoist cable 302 can then be reconnected to the upper spacers 118a and 118b. The handles 116b of the adjusting members then are rotated in an opposite direction they were rotated to engage the parapet 304 until a gap between the parapet 304 and the engaging members 106 is achieved. The parapet anchor 100 is then pushed away from the parapet 304. Using a hoist and the hoist cable 302 the parapet anchor 100 is moved to the desired location. The hoist cable 302 is then removed. Once the parapet anchor 100 has been removed and positioned in a safe location it can then be prepared for reuse or storage. Referring to FIG. 9, a partial back side perspective view of the parapet anchor 100 is provided. This view illustrates the parapet anchor 100 in a storage position. In this position, detent pins 122 are initially removed from passages 111 and 107a and 107b. This allows the upper support members 110a and 110b of the upper support assembly 204 of the parapet anchor 100 to slide down along the lower support members 108a and 108b of the lower assembly 202 until ends of the upper support members 110a and 110b rest on the first and second lower members 102a and 102b. The detent pins 122 can then be reinserted in passages 107a and 107b of the lower support members 108a and 108b for storage. FIG. 9 further illustrates that in one embodiment, a connector 902 that provides an anchor point to the parapet anchor 100 is coupled to the davit mount 140.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A parapet anchor comprising:
a frame configured and arranged to fit around a portion of a parapet;
at least one adjustment member movably coupled to the frame to selectively engage the parapet to secure the frame to the parapet; and
a davit mount coupled to the frame configured and arranged to support a davit.

2. The parapet anchor of claim 1, further comprising:
a handle coupled and arranged to aid in selectively increasing and decreasing a size of the frame.

3. The parapet anchor of claim 2, further comprising:
at least one upper spacer configured and arranged to aid in the positioning of the parapet anchor in a select location.

4. The parapet anchor of claim 1, further comprising:
a connector coupled to the frame, the connector configured and arranged to provide an anchor point to the parapet anchor.

5. The parapet anchor of claim 1, wherein the at least one adjustment member further comprises:
a threaded shaft that is threadably engaged with the frame, the threaded shaft having a first end and a second end;
an adjustment handle coupled about the first end of the threaded shaft, the adjustment handle providing ease of rotation of the threaded shaft; and
an engaging head coupled to the second end of the threaded shaft, the engaging head configured and arranged to engage a surface of the parapet.

6. The parapet anchor of claim 5, wherein the engaging head of the at least one adjustment member is threadably engaged with a threaded bore in the second end of the threaded shaft of the at least one adjustment member.

7. The parapet anchor of claim 1, wherein the frame further comprises:
a first lower member having a first end and a second end;
a second lower member spaced in a parallel fashion from the first lower member by at least one lower frame spacer, the second lower member having a first end and a second end;
a first upper member having a first end and a second end;
a second upper member spaced in a parallel fashion from the first upper member by at least one upper frame spacer, the second upper member having a first end and a second end;
a first support member coupled between the first lower member and the first upper member, the first support member coupled proximate the second end of the first lower member and proximate the second end of the first upper member such that the first upper member and the first lower member extend from the first support member in the same direction; and
a second support member coupled between the second lower member and the second upper member, the second support member coupled proximate the second end of the second lower member and proximate the second end of the second upper member such that the second upper member and the second lower member extend from the second support member in the same direction, wherein the first upper member is generally spaced a distance over the first lower member and the second upper member is spaced a distance over the second lower member.

8. The parapet anchor of claim 7, further comprising:
the first support member including a first upper support member and a first lower support member, the first lower support member configured and arranged to be selectively coupled to the first upper support member; and
the second support member including a second upper support member and a second lower support member, the second lower support member configured and arranged to be selectively coupled to the second upper support member.

9. A parapet anchor comprising:
at least one upper member;
at least one lower member;
at least one support member coupling the at least one upper member to the at least one lower member to form a generally C-shaped frame;
at least one adjustment member adjustably engaged with the at least one upper member, the at least one adjustment member having a first end that selectively moves relative to the at least one lower member to selectively engage and disengage a structure positioned between the at least one upper member and the at least one lower member;
at least one upper spacer coupled to the frame to aid in the positioning of the parapet anchor; and
a davit mount coupled to the frame, the davit mount configured to support a davit.

10. The parapet anchor of claim 9, further comprising:
at least one mounting member coupled the at least one support member, the mounting member configured and arranged to provide an anchor point to the parapet anchor.

11. The parapet anchor of claim 9, further comprising:
a connector coupled to the frame, the connector configured and arranged to couple a hoist cable to the frame.

12. The parapet anchor of claim 9, further comprising:
an upper engaging head coupled to the first end of the at least one adjusting member to engage the structure positioned between the at least one upper member and the at least one lower member; and
at least one lower engaging head coupled to the at least one lower member, the at least one lower engage head configured and arranged to engage the structure positioned between the at least one upper member and the at least one lower member.

13. The parapet anchor of claim 9 further comprising:
a handle including,
at least one connection flange selectively coupled to a portion the at least one support member, and
a grasping rod coupled to the at least one connection flange.

14. A parapet anchor comprising:
a first lower member having a first end and a second end;
a second lower member spaced in a parallel fashion from the first lower member by at least one lower frame spacer, the second lower member having a first end and a second end;
a first upper member having a first end and a second end;
a second upper member spaced in a parallel fashion from the first upper member by at least one upper frame spacer, the second upper member having a first end and a second end;
a first support member coupled between the first lower member and the first upper member, the first support member coupled proximate the second end of the first lower member and proximate the second end of the first upper member such that the first upper member and the first lower member extend from the first support member in the same direction;
a second support member coupled between the second lower member and the second upper member, the second support member coupled proximate the second end of the second lower member and proximate the second end of the second upper member such that the second upper member and the second lower member extend from the second support member in the same direction, wherein the first upper member is generally spaced a distance over the first lower member and the second upper member is spaced a distance over the second lower member;
at least one adjustment member for each of the first and second upper members, each adjustment member threadably engaged with a respective first and second upper member to selectively engage a structure positioned between the first and second upper members and the first and second lower members to secure the parapet anchor to the structure; and
a davit mount coupled to the first and second support members, the davit mount configured to support a davit.

15. The parapet anchor of claim 14, further comprising:
the first support member including a first upper support member and a first lower support member, the first lower support member configured to be selectively coupled to the first upper support member; and
the second support member including a second upper support member and a second lower support member, the second lower support member configured and arranged to be selectively coupled to the second upper support member.

16. The parapet anchor of claim 15, further comprising:
the first lower support member selectively received inside the first upper support member; and
the second lower support member selectively received inside the second upper support member.

17. The parapet anchor of claim 16, further comprising:
the first upper support member passing through the first upper member; and
the second upper support member passing through the second upper member.

18. The parapet anchor of claim 17, further comprising:
a handle coupled to the parapet anchor, the handle including,
a first connection flange selectively coupled to a portion the first lower support member extending out of the first upper support member proximate the first upper member, and
a second connection flange selectively coupled to a portion the second lower support member extending out of the second upper support member proximate the second upper member, and
grasping rod coupled between the first and second connection flanges.

19. The parapet anchor of claim 18, wherein the handle is configured and arranged to selectively aid in increasing and decreasing a space between the first and second lower members and the first and second upper members.

20. The parapet anchor of claim 19, the at least one adjustment member further comprises:
a threaded shaft having a first end and a second end;
an adjustment handle coupled about the first end of the threaded shaft, the adjustment handle providing ease of rotation of the threaded shaft; and
an engaging head coupled to the second end of the threaded shaft, the engaging head configured and arranged to engage a surface of the parapet.
